(19) United States
(12) Patent Application Publication
(10) Pub. No.: US 2004/0022393 A1
(43) Pub. Date: Feb. 5, 2004

(54) Signal processing system and method

(75) Inventor: Marcus Richard Jones, Lincoln (GB)

Correspondence Address: James M. Bagarazzi, DORITY & MANNING, P.A., P.O. Box 1449, Greenville, SC, 29602, US

(73) Assignee: Zarlink Semiconductor Limited

(21) Appl. No.: 10/461,996

(22) Filed: Jun. 12, 2003

(30) Foreign Application Priority Data
Jun. 12, 2002 (GB) 0213501.0

(51) Int. Cl. H04R 29/00; H04R 3/00

(52) U.S. Cl. 381/56; 381/92; 381/122

(57) ABSTRACT

A sound transmission system comprises-a microphone, an amplifier, a low-pass filter, an ADC, a digital signal processor (DSP), a digital interface, a buffer, and a transport medium interface. The low-pass filter removes unwanted out-of-band signals, and the ADC converts the filtered analog signal to digital form. The DSP receives the digital data from the ADC and performs gain and filtering operations in the digital domain. The digital interface operates on the data and places it on the buffer where the data is stored prior to being transmitted over some channel via the transport medium interface. By powering down one or more particular components of the sound transmission system, most notably the ADC, the DSP and the digital interface, when the received signal falls below a predetermined level, power consumption is reduced.

### CROSS-REFERENCE TO RELATED APPLICATIONS

The present application claims priority to currently pending United Kingdom Patent Application number 0213501.0, filed Jun. 12, 2002.

### STATEMENT REGARDING FEDERALLY SPONSORED RESEARCH OR DEVELOPMENT

N/A

### BACKGROUND OF THE INVENTION

This invention relates to a signal processing system, and particularly, though not exclusively, to a signal processing system for operating on analog signals, or digital data, obtained in a logging or measurement operation. The invention also relates to an adaptive signal processing method.

Signal processing systems are well known for use in many applications. For example, a digital sound transmission system may include a data processing system used to measure and analyze an audio-frequency signal by means of receiving the signals using a microphone, converting the analog signal into digital data, and performing some data processing operation on the data, e.g. a filtering operation. The data may then be logged or transmitted over a channel to some other component.

In electrical or electronic systems, it is desirable to reduce the amount of consumed power.

### OBJECTS AND SUMMARY OF THE INVENTION

Additional objects and advantages of the invention will be set forth in part in the description that follows, and in part will be obvious from the description, or may be learned by practice of the invention. The objects and advantages of the invention may be realized and attained by means of the instrumentalities and combinations particularly pointed out in the appended claims.

According to a first aspect of the invention, there is provided a signal processing system, comprising: means arranged to receive a signal; signal processing means for conditioning a signal received by the receiving means; and control means arranged to (a) monitor the magnitude of a signal received by the receiving means; and (b) to disable the signal processing means when the magnitude of the received signal falls within a predetermined magnitude range.

The signal processing system can be applied to both analog and digital signals.

According to a second aspect of the invention, there is provided a data processing system comprising: analog-to-digital conversion means; data processing means for operating on data generated by the analog to digital conversion means; and control means arranged to (a) monitor the magnitude of a signal received by the analog to digital conversion means and (b) to disable one or both of the analog to digital conversion means and the data processing means when the magnitude of the received signal falls within a predetermined magnitude range.

Such signal processing systems can be considered adaptive in the sense that, if the magnitude of the received signal is within a particular range, a signal conditioning means, e.g. in the case of a digital implementation, one or both of the analog to digital conversion means (hereafter referred to as ‘the ADC’) and/or the data processing means is disabled, thereby reducing power consumption. This provides much more effective power reduction than, say, simply, ‘muting’ the microphone in the event of the received signal magnitude falls within a particular range. The signal processing system can be considered to be in a low power mode.

In the context of this application, the predetermined magnitude range can be defined by a single level, so that if the magnitude of the received signal falls below the level, then the low-power mode is entered. Alternatively, the predetermined magnitude range could be defined as occupying anywhere above the level. Alternatively still, the predetermined magnitude range can be defined by two levels whereby the low-power mode is entered if the magnitude of the received signal falls between the two levels. This is particularly useful in audio applications since an audio signal will fluctuate about a mid-rail level, and so two outer boundaries are defined. As a further option, the low-power mode might only be entered if the received signal is outside of the two levels.

As mentioned, the system provides for monitoring of the magnitude of the received signal. In this respect, it will be appreciated that analog signals may be measured about a mid-rail voltage, e.g. zero volts, with signals having measurable significance even at a negative voltage. Thus, the sign of the monitored magnitude level need not be important.

The control means may be arranged to monitor the magnitude of the received analog signal by means of directly monitoring the received data, or indirectly, by monitoring the data output from the ADC (the data representing the received analog signal in digital form).

The control means may further include comparator means for comparing the monitored magnitude of a received signal with at least one reference signal representing at least one level the predetermined magnitude range, the comparator means outputting a disabling signal to one or both of the ADC and the data processing means when the received signal falls within the predetermined magnitude level. Analog or digital comparator means can be used.

The system may further comprise a digital interface arranged to receive data from the data processing means and to output the data to an output port capable of being connected to a transmission channel, the control means being further arranged to cause padding samples to be generated at the digital interface when the received signal falls within the predetermined magnitude range. In this respect, it will be appreciated that in situations where a further processor system is to be connected to the data processing system of the invention, via some channel, it may be important for a data stream (or bit stream) transmitted over the channel to be maintained, even though the ADC and data processing means have been disabled. This may be needed for synchronization purposes. It is for this reason that padding samples are provided. The control means may be arranged to cause padding samples to be generated only after a predetermined time interval from when the one or both of the ACC and the data processing means have been disabled. This provides time for the normal operation of the ADC and the data processing means to complete and for the data to be transferred over a channel before such padding samples are generated.

The control means may be arranged to cause padding samples to be generated at an magnitude which is the same as that of the last bit of data received from the data processing means prior to when the received signal fell within the predetermined magnitude range.

The system may further comprise an audio transducer connected to the ADC. The audio transducer may be a microphone for converting audio frequency samples into an analog electrical signal.

The control means can be arranged to disable one or both of the ADC and the data processing means by means of disabling clocking signals which are fed to the or each respective means. In this respect, it will be appreciated that in many systems, the ADC and data processing means consume power due to the clocking signals that are continuously fed to them. Accordingly, an effective way of reducing power consumed by the overall circuit is to disable the, or each clocking signal fed to the ADC and data processing means.

Although ADC and data processing means have been mentioned above, other components which form part of a digital processing system can also be inhibited if the magnitude of the monitored signal falls within the predetermined magnitude range. For example, amplification, digital signal processing (DSP) modules, and filtering modules can be disabled in such an event.

In a third aspect of the invention, there is provided an adaptive signal processing method in a signal processing system including signal processing means for operating on a signal received by the system, the method comprising: monitoring the magnitude of a signal received by the signal processing means; and disabling the signal processing means when the magnitude of the received signal falls within a predetermined magnitude range.

In a fourth aspect of the invention, there is provided an adaptive data processing method in a data processing system including ADC and data processing means for operating on data generated by the analog to digital conversion means, the method comprising: monitoring the magnitude of a signal received by the analog to digital conversion means; and disabling one or both of the analog to digital conversion means and the data processing means when the magnitude of the received signal falls within a predetermined magnitude range.

The monitoring step may comprise monitoring the data output from the analog to digital conversion means.

The monitoring step may include using a comparator means to compare the monitored magnitude of the received signal with at least one reference signal representing one or more boundary levels of the predetermined magnitude range, and outputting a disabling signal from the comparator means to one or both of the analog to digital conversion means and the data processing means when the received signal falls within the predetermined magnitude level.

The data processing system may include a digital interface for receiving data from the data processing means and for outputting the data to a transmission channel. In this case, the method may further comprise outputting one or more padding samples from the digital interface to the transmission channel when the received signal falls within the predetermined magnitude range. The or each padding sample can be outputted only after a predetermined time interval from when the one or both of the analog to digital conversion means and the data processing means have been disabled.

The or each padding sample can be outputted at an magnitude which is the same as that of the last bit of data received from-the data processing means prior to when the received signal fell within the predetermined magnitude range. The, or each, padding sample may be read from a padding sample register which stores a predetermined padding sample.

The signal received by the analog to digital conversion means can be derived from an audio transducer, e.g. a microphone for converting audio frequency samples into an analog electrical signal.

The step of disabling one or both of the analog to digital conversion means and the data processing means can comprise disabling clocking signals which are fed to the or each respective means.

In a fifth aspect of the invention, there is provided a computer program comprising computer readable instructions stored on a computer-usable medium, the computer program being arranged to perform an adaptive data processing method in a is data processing system including analog to digital conversion means and data processing means for operating on data generated by the analog to digital conversion means, the method comprising: monitoring the magnitude of a signal received by the analog to digital conversion means; and disabling one or both of the analog to digital conversion means and the data processing means when the magnitude of the received signal falls within a predetermined magnitude range.

In a sixth aspect of the invention, there is provided an audio transmitting system comprising: an audio receiver for receiving an audio-frequency analog signal; signal processing means for operating on a signal received by the audio receiver; and control means arranged to (a) monitor the magnitude of a signal received by the audio receiver and (b) to disable the signal processing means when the magnitude of the received signal falls within a predetermined magnitude range.

In a seventh aspect of the invention, there is provided an audio transmitting system comprising: an audio receiver for receiving an audio-frequency analog signal; analog to digital conversion means connected to the audio receiver; data processing means for operating on data generated by the analog to digital conversion means; and control means arranged to (a) monitor the magnitude of a signal received by the analog to digital conversion means and (b) to disable one or both of the analog to digital conversion means and the data processing means when the magnitude of the received signal falls within a predetermined magnitude range.

The accompanying drawings, which are incorporated in and constitute a part of this specification, illustrate at least one presently preferred embodiment of the invention as well as some alternative embodiments. These drawings, together with the description, serve to explain the principles of the invention but by no means are intended to be exhaustive of all of the possible manifestations of the invention.

### BRIEF DESCRIPTION OF THE DRAWINGS

FIG. 1 is a block diagram of a sound transmission system, which is useful for understanding the invention;

FIG. 2 is a block diagram of a sound transmission system that includes an analog power reduction facility;

FIG. 3 is a block diagram of a sound transmission system having a digital power reduction facility; and

FIG. 4 is a functional block diagram of a decision logic block that is shown in FIGS. 2 and 3.

### DETAILED DESCRIPTION OF THE PREFERRED EMBODIMENTS

Reference now will be made in detail to the presently preferred embodiments of the invention, one or more examples of which are illustrated in the accompanying drawings. Each example is provided by way of explanation of the invention, which is not restricted to the specifics of the examples. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. The same numerals are assigned to the same components throughout the drawings and description.

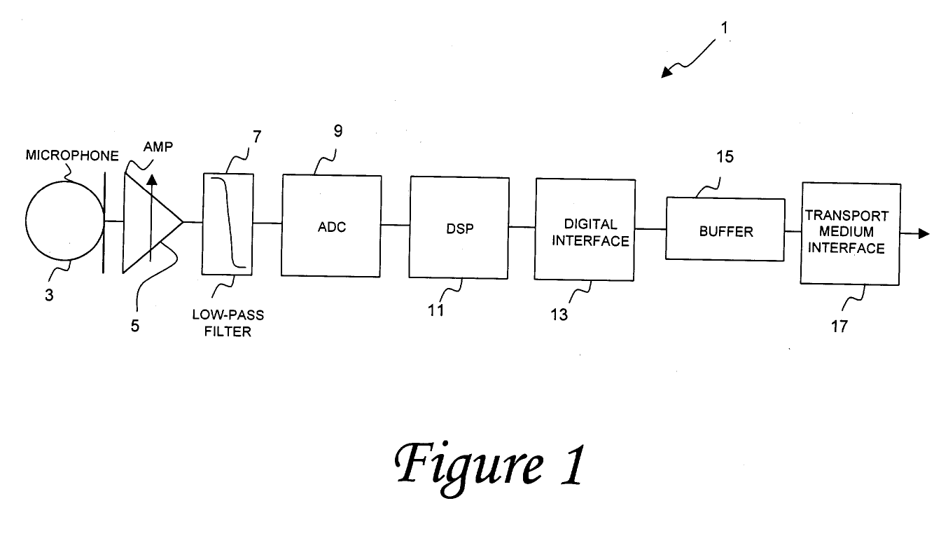

Referring to FIG. 1, a typical sound transmission system 1 comprises a microphone 3, an amplifier 5, a low-pass filter 7, an ADC 9, a digital signal processor (DSP) 11, a digital interface 13, a buffer 15, and a transport medium interface 17. As will be understood, the microphone 3 receives audio-frequency sound and converts the sound to an analog signal. The low-pass filter 7 removes unwanted out of band signals, and the ADC 9 converts the filtered analog signal to digital form. The DSP 11 receives the digital data from the ADC 9 and performs gain and filtering operations in the digital domain. The digital interface 13 operates on the data and places it on the buffer 15 where the data is stored prior to being transmitted over some channel (not shown) via the transport medium interface. In low power applications, the power consumed by the components of this serial path are a significant power drain. As will be described below, by powering down one or more particular components of the sound transmission system 1, most notably the ADC 9, the DSP 11 and the digital interface 13, when the received signal falls below a predetermined level, power consumption can be reduced. While the example, which will be described in particular detail below, is a sound transmission system 1, the same principle can be applied to other forms of data processing systems, such as data logging and measurement systems. As with a sound transmission system, these later examples are also characterized in that the received signal is effectively idle for significant periods of time.

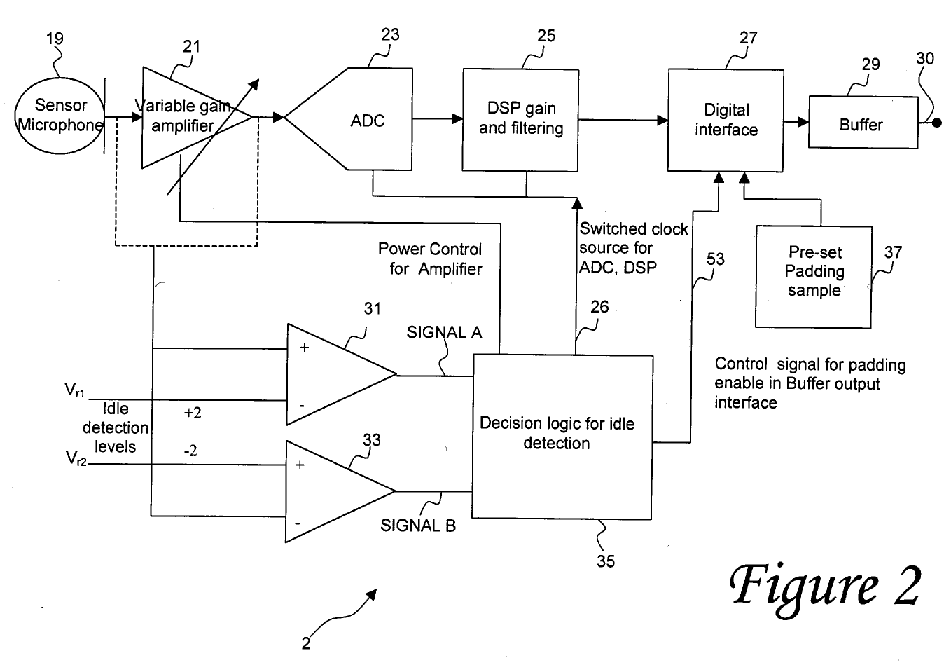

Referring now to FIG. 2, a further sound transmission system 2, which includes a power-reduction capability, is shown. The sound transmissions system 2 comprises a microphone 19, a variable gain amplifier 21, an ADC 23, a DSP 25, a digital interface 27, a buffer 29, first and second comparators 31, 33, decision logic 35, and a padding sample register 37.

As will be appreciated, audio-frequency sound received by the microphone 19 is converted to an analog electrical signal. This analog signal will fluctuate between positive and negative levels about a mid-rail voltage, for example, zero volts. Thus, when little or no sound is received by the microphone 19, the analog signal from the microphone 19 will be at, or close to, the mid-rail voltage. In order to detect an ‘idle’ condition, i.e. the condition whereby the received signal is close to the mid-rail voltage, predetermined first and second reference voltages Vr1, Vr2 are applied to the first and second comparators 31, 33. Specifically, the first reference voltage Vr1 is applied to the negative terminal of the first comparator 31, while the second reference voltage Vr2 is applied to the positive terminal of the second comparator 33. The other terminal of the first and second comparators 31, 33 is connected to either the input or the output terminal of the variable gain amplifier. If the signal from the microphone 19 is of a sufficient magnitude to allow direct comparison with the first and second reference voltages Vr1, Vr2 then the signal from the microphone 19 is fed directly to the first and second comparators 31, 33. Otherwise, if the signal is not at a sufficient magnitude, the signal is amplified by the variable gain amplifier 21 before being fed to the first and second comparators 31, 33.

The first reference voltage Vr1 defines a positive voltage threshold, and so if the received analog signal is below this threshold, the output of the first comparator 31 will be a positive voltage level. The second reference voltage Vr2 defines a negative voltage threshold, and so if the received analog signal is above this threshold, the output of the second comparator will be a negative voltage level. The outputs from the first and second comparators 31, 33 are fed to the decision logic 35 that determines, using the signals from the comparators, whether the received analog signal is below the first reference voltage Vr1 and above the second reference voltage Vr2. If so, then the sound transmission system 2 is in an idle condition.

The output of the variable gain amplifier 21 is fed to the ADC 23 that converts the received analog signal into digital form. The digital data is then fed to the DSP 25 that performs, amongst other digital domain processing operations, gain and filtering operations. The operation of the ADC 23 and the DSP 25 is controlled by a common clocking signal that is received from the decision logic 35 by means of a line 26. The output from the DSP 25 is fed to the digital interface that prepares the data for storage on the buffer 29. The buffer 29 is connected to a data port 30 to which can be connected a further device so that the processed data can be transmitted over some channel.

As mentioned above, the decision logic 35 determines, using the signals from the comparators, whether the received analog signal is below the first reference voltage Vr1 and above the second reference voltage Vr2, in which case an idle condition exists. The decision logic 35 also determines the elapsed time over which a detected idle condition has existed. If the elapsed time exceeds the time that the ADC 23 and the DSP 25 require to process the received data, (i.e. the data received before the idle condition was detected) then the decision logic 35 is configured to cause the sound transmission system 2 to enter a low power mode. This elapsed time comparison is performed to ensure that the ADC 23 and the DSP 25 have had sufficient time to process all valid data that has been received and so that no data is lost. The sound transmission system 2 enters the low power mode by means of the decision logic 35 inhibiting the clocking signals to the ADC 23 and the DSP 25 on the common line 26 and they are powered down. This results in a significant power saving. If the first and second comparators 31, 33 are fed with the received signal directly, rather than from the variable gain amplifier 21, then the amplifier can also be powered down. Once the low power mode is entered, the received signal is monitored until such time as the idle condition no longer exists, at which point the low power mode is cancelled and the system operates as before.

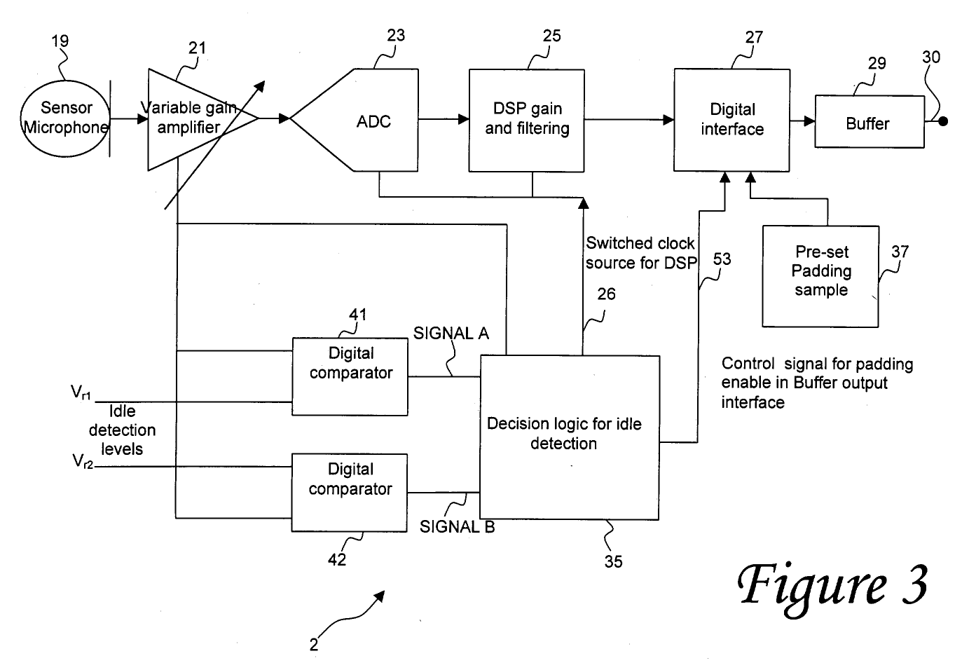

Referring briefly to FIG. 3, in which a digital implementation of the above sound transmission system 2 is shown, it will be seen that the only significant change to the system structure is that first and second digital comparators 41, 42 are used (rather than analog comparators) and the input to the comparators is fed from the output of the ADC 23. The reference voltages Vr1 and Vr2 will be represented in digital form. In this case, however, it is only the DSP 25 that can be powered-down in the idle condition since the ADC 23 needs to provide data to the comparators so that a non-idle condition can be detected.

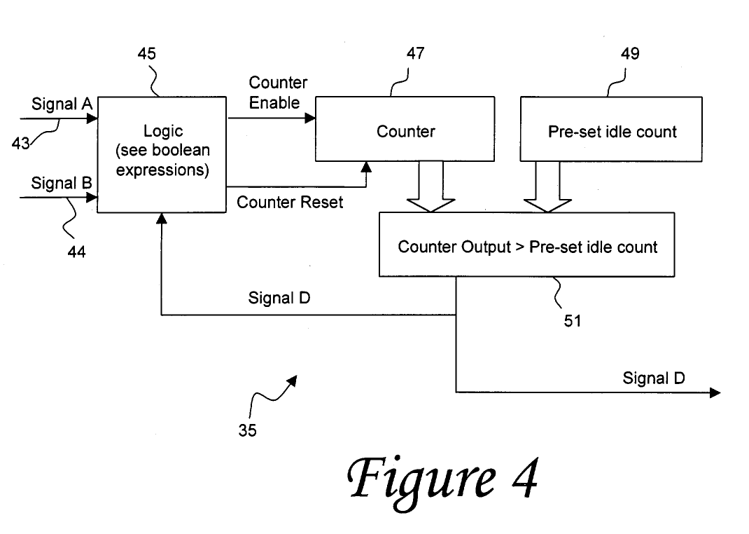

Referring to FIG. 4, the decision logic 35 comprises control logic 45, a counter 47, an idle count register 49 and a decision block 51. The ‘count enable’ output from the control logic 45 is used to start the counter 47. The ‘count reset’ output from the control logic 45 is used to reset the counter 47 to zero. When the control logic 45 detects the idle condition, the count enable signal is set active and the counter 47 will count the number of clock cycles for which the idle condition exists. If the control logic 45 detects that the idle condition is no longer present, i.e. because the received signal is outside of the first and second reference voltages Vr1, Vr2, then the ‘count enable’ signal is set inactive and the count “reset signal” is set active to clear the counter 47. If the value in the counter 47 reaches a value that exceeds a predetermined value stored in the idle count register 49, then a signal “D” is made active. This decision is made by the decision block 51, which generates the active “D” signal. This active “D” signal is then used to power-down one or more of the ADC 23, the DSP 25, and even the variable gain amplifier 21 and the digital interface. As mentioned above, the ADC 23 and the DSP 25 can be powered down by means of inhibiting clocking signals fed to them on the line 26.

Another use of the active “D” signal is to control the digital interface 27, via line 53, to cause it to generate padding samples for transfer to the buffer 29. The padding samples are generated by means of reading a pre-stored padding sample from the padding sample register 37 and loading them to the buffer 29. The purpose of “padding” the output from the sound transmission system 2 is to ensure that a continuous data stream is fed to the buffer 29 (and so any later processing stage) even when the system is powered-down.

The active “D” signal is also fed back to the control logic 45. This causes the “count enable” signal to be set inactive, while the “count reset” signal remains inactive, which stops the counter 47 from counting. This is performed to prevent the counter from rolling over its own maximum count value and also to save power during extended periods when the idle condition exists.

The pre-stored idle count in the idle count register 49 is set at a value that allows the signal path from the microphone 19 to the digital interface 27 (via the intermediate stages of the variable gain amplifier 21, the ADC 23, and the DSP 25) to process all of the valid data (received prior to the idle condition being detected). For example, if the analog circuit of FIG. 2 is used, the ADC 23 may require four clock cycles to perform a single conversion, the DSP 25 may require one hundred clock cycles to process each bit of data before it arrives at the digital interface 27 which itself may require two clock pulses to output the sample to the buffer 29. In this case, therefore, the idle count register 49 is configured with a value of one hundred and six. Accordingly, this ensures that the last valid sample received will be placed in the buffer 30 prior to the time when signal “D” becomes active and the low power mode is entered.

The above-described functions which are to be performed by the control logic 45 can be described in terms of Boolean algebra terms. Indeed, for the “count enable” signal and the “count reset” signal, there are four ways in which the logic can be configured to fulfill four possible idle condition scenarios.

Signal Definitions (note that signal A and signal B are indicated in FIGS. 1 to 3)

Signal A→ ‘upper threshold compare signal’=received signal>Vr1

Signal B→ ‘lower threshold compare signal’=received signal>Vr2

Signal D→ ‘idle condition detected’=output from counter 47>value in idle count register 49

Idle Condition Scenarios

Scenario 1—the idle condition occurs when the received signal magnitude is between the upper and lower limits (i.e. Vr1 and Vr2). In audio applications, such as that described above, this would be the idle scenario employed. The received signal will be close to the mid-rail level to indicate a period of silence, or near-silence, in the received audio.

Count enable=\overline{Signal} A AND Signal B AND \overline{Signal D}

Count reset=\overline{Signal A} OR \overline{Signal B}

Other scenarios can be employed in different applications. In a second scenario, the idle condition occurs when the received signal is above the upper limit or below the lower limit. In this case, the expressions will be:

Count enable=(Signal A OR \overline{Signal} B) AND \overline{Signal D}

Count reset=\overline{Signal} A AND Signal B

In a third scenario, the idle condition occurs when the received signal is above one limit, here the upper limit:

Count enable=Signal A AND \overline{Signal D}

Count reset=\overline{Signal A}

In a fourth scenario, the idle condition occurs when the received signal is below one limit, here the lower limit:

Count enable=\overline{Signal B} AND \overline{Signal D}

Count reset=Signal B

As a variation to using the padding sample register 37 for storing the padding sample, the digital interface 27 can be arranged to generate a repeat of the last data sample before the idle condition was detected. This sample would be repeated until the idle condition is cancelled.

The above sound transmission system could form part of a low power implementation, such as being part of an audio headset device, a hearing aid, a portable digital assistant (PDA), a mobile telephone, or dictation machine. Also, other battery-powered devices such as a measurement or data logging device, a minidisk recorder, or an MP3 recorder could utilise such a system.

While the above embodiments are based around a digital data processing system and method, it will be clear to a person skilled in the art that the digital signal processing components can be replaced with analogue signal processing means, and analogue comparators used instead of digital comparators.

While at least one presently preferred embodiment of the invention has been described using specific terms, such description is for illustrative purposes only, and it is to be understood that changes and variations may be made without departing from the spirit or scope of the following claims.

What is claimed is:

1. A signal processing system, comprising:
a signal receiver,
a signal processor, and
a controller configured to (a) monitor the magnitude of a signal received by the signal receiver, and (b) disable the signal processor when the magnitude of the received signal falls within a predetermined magnitude range.

2. A data processing system comprising:
an analog to digital converter,
a data processor, and
a controller configured to (a) monitor the magnitude of a signal received by the analog to digital converter and (b) disable one or both of the analog to digital converter and the data processor when the magnitude of the received signal falls within a predetermined magnitude range.

3. A system according to claim 2, wherein the controller is configured to monitor the magnitude of the received signal by monitoring the data output from the analog-to-digital converter.

4. A system according to claim 2, wherein the controller includes a comparator for comparing the monitored magnitude of a received signal with at least one reference signal representing at least one boundary level of the predetermined magnitude range, the comparator outputting a disabling signal to one or both of the analog to digital converter and the data processor when the received signal falls within the predetermined magnitude range.

5. A system according to claim 2, further comprising:
a digital interface having an input and an output, wherein the data processor has an output and the input of the digital interface is connected to the output of the data processor, and wherein the controller is further configured to cause padding samples to be generated at the digital interface when the received signal falls within the predetermined magnitude range.

6. A system according to claim 2, further comprising:
a digital interface having an input and an output, wherein the data processor has an output and the input of the digital interface is connected to the output of the data processor, and wherein the controller is further configured to cause padding samples to be generated after a predetermined time interval from when the one or both of the analog to digital converter and the data processor have been disabled.

7. A system according to claim 5, wherein the padding samples are generated at the same magnitude as that of the last bit of data received from the data processor prior to when the received signal fell within the predetermined magnitude range.

8. A system according to claim 5, wherein the padding samples are generated by reading a pre-stored padding sample from a register.

9. A system according to claim 2, further comprising an audio transducer connected to the analog to digital converter.

10. A system according to claim 9, wherein the audio transducer is a microphone.
